(19) United States
(12) Patent Application Publication
(10) Pub. No.: US 2020/0120919 A1
(43) Pub. Date: Apr. 23, 2020

(54) MULTI-CATCH RODENT AND INSECT TRAP

(71) Applicant: AP&G Co., Inc., Bayonne, NJ (US)

(72) Inventor: Edward William Dolshun, Warwick, NY (US)

(21) Appl. No.: 16/661,722

(22) Filed: Oct. 23, 2019

Related U.S. Application Data
(60) Provisional application No. 62/749,243, filed on Oct. 23, 2018.

(51) Int. Cl. A01M 23/00; A01M 23/16; A01M 1/14

(52) U.S. Cl. CPC A01M 23/005; A01M 1/14; A01M 23/16

(57) ABSTRACT

A multi-catch trap unit configured to trap rodents and insect using two respective modalities. The trap is formed of a housing or similar container that is configured to receive one or more mechanical rodent traps. A glue board also is provided that is foldable to form a right angle. The glue board is used to trap insects, and a vertical portion of the glue board also functions to separate an insect-trapping chamber from the rodent-trapping chamber.

### RELATED APPLICATIONS

This application claims the benefit of pending U.S. Prov. Appl. 62/749,243 filed Oct. 23, 2018, the contents of which are incorporated by reference herein.

### FIELD OF THE INVENTION

The invention relates to the field of rodent and insect abatement devices, more specifically to a combined rodent and insect trap.

### BACKGROUND OF THE INVENTION

Rodent and insect traps are routinely used in residential and commercial settings. Commonly used trapping devices include mechanical traps and glue boards. It may be desirable to use different trapping modalities to target different rodents or insects. For instance, a user may want to employ mechanical traps to capture rodents and glue boards to catch insects. There is a need in the art for a single trap unit that contains mechanical traps for killing rodents and glue boards for trapping insects.

### SUMMARY OF THE INVENTION

The invention set forth herein is a multi-catch unit that is configured to trap rodents and insects. The multi-catch unit that is dividable into two distinct chambers. A first chamber is provided with one or more mechanical rodent traps for trapping rodents. The second chamber is provided with a glue board for trapping insects. The inserted glue board is scored down the middle allowing for it to be folded lengthwise down its center to form two glue board sections. A first glue board section is placed on the floor of the multi-catch unit, whereas, a second section serves as a dividing wall between the first and second chambers.

The sidewalls of the multi-catch unit have openings that are sized and shaped to allow rodents and insects to enter into the unit. For example, openings on sidewall sections proximate to the first chamber are configured to allow the entry of rodents, such as mice or rats. Opening on sidewall sections proximate to the second chamber are large enough to allow the passage of insects but are too small to allow the entry of rodents.

In embodiments of the invention, tabs protruding from the inner side walls of the multi-catch unit are configured to support the second glue board section (e.g. the wall portion) in place substantially orthogonally to the floor of the unit.

### BRIEF DESCRIPTION OF THE DRAWINGS

FIG. 1 is an exploded view of a multi-catch unit and the trapping devices to be secured therein in an accordance with an exemplary embodiment of the invention.

FIG. 2 is a multi-catch unit prior to being adapted for dual use, whereby a scored glue board is positioned to be folded and inserted into the multi-catch unit in accordance with an exemplary embodiment of the invention.

FIG. 3 is a top perspective view of a multi-catch unit configured with two chambers in accordance with an exemplary embodiment of the invention.

FIG. 4 is a partial enlarged view of a glue board supported by tabs in a multi-catch unit according to an exemplary embodiment of the invention.

FIG. 5 shows an enlarged view of a tab used to maintain a section a glue board in a vertical position according to an exemplary embodiment of the invention.

### DETAILED DESCRIPTION OF THE INVENTION

The following is a detailed description of the preferred embodiments of the invention, reference being made to the drawings in which the same reference numerals identify the same elements of structure in each of the several figures. It should be noted that these drawings are merely exemplary in nature and in no way serve to limit the scope of the invention.

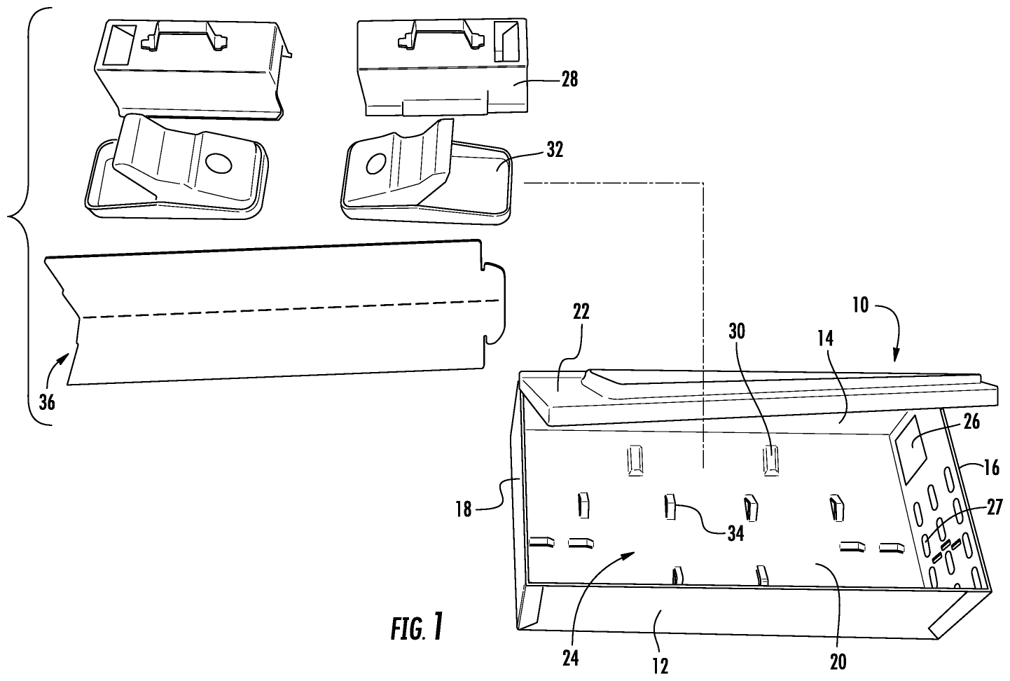

Referring to FIG. 1, a multi-catch unit 10 and components to be secured therein are shown. The multi-catch unit 10 is a rectangular box or similar housing having a front wall 12, a rear wall 14, a right side wall 16, a left side wall 18, a bottom wall 20 and a cover 22. Walls 12, 14, 16, 18 have outer and inner surfaces and bottom wall 20 has an inner surface and an underside surface (not shown) that rests on the floor. In embodiments of the invention, cover 22 is hingedly connected to rear wall 14. Inner surfaces of respective walls 12, 14 16, 18 and 20 form an internal cavity 24 that is adapted to receive trapping devices.

As shown, a cutout 26 in right sidewall 16 serves as a door to allow a rodent to enter into the internal cavity 24. A one-way tunnel 28 is placed at the cutout 26 which has an opening that is substantially in register with opening 26. One-way tunnel 28 ensures that a rodent that enters into the internal cavity 24 cannot back out of the unit 10. Tabs (e.g. 30) are provided on bottom wall 20 to secure tunnel 28 in place.

One or more smaller holes 27 also are provided on right sidewall 16. Holes 27 may of any of various shapes (e.g. round, ovular etc.) and are configured to selectively allow the ingress of insects but prevent entry by rodents such as mice. In this regard, holes 27 are sized to be smaller than the outside dimensions of a rodent.

It will be understood that left sidewall 18 may be a substantially mirror image of right sidewall 16 such that openings for rodents and insects are provided on either side of the trap. In this regard, once the multi-catch unit is placed down (e.g. on a floor or similar surface of an area where rodent and insects are suspected), rodents and insects may enter the multi-catch unit 10 from two opposing directions.

One or more mechanical rodent traps 32 also are secured to the bottom wall of the unit 10 (e.g. via tabs 34).

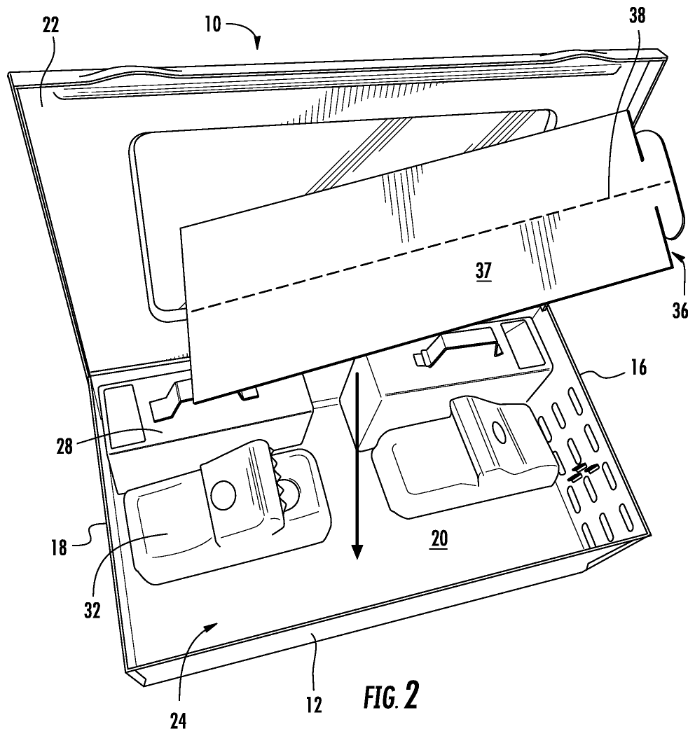

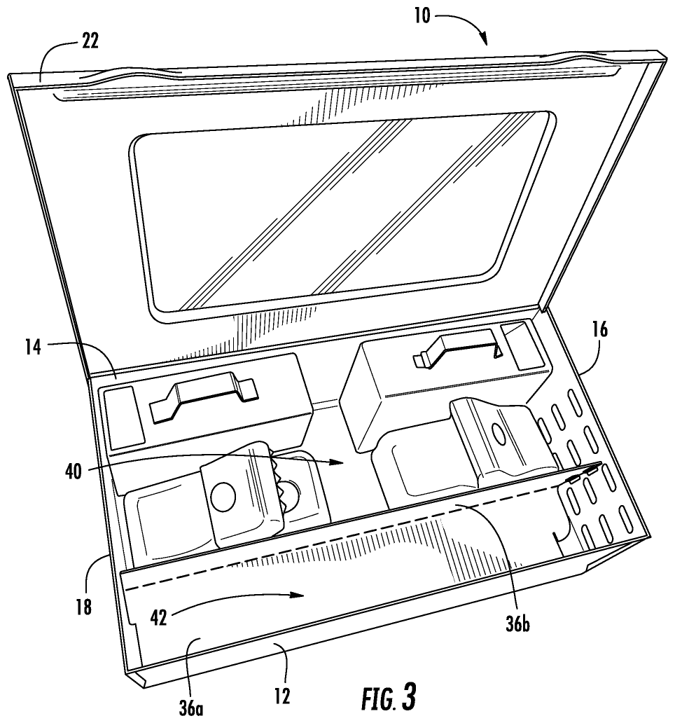

As best shown in FIG. 2 a glue board 36 configured for use in embodiments of the invention has a score 38, perforation or similar longitudinal weakening that serves as a focal point for folding the glue board 36 down its length. It will be understood that a line configured to focus a fold may be a thinned area of the glue board, a previously imparted fold or any other material weakening. In this regard, prior to inserting the glue board 36, a user folds the glue board 36 along its length to create a substantial right angle. Thus, the folded glue board 36 has a first section 36a and a second section 36b that is substantially orthogonal to the first section 36a (e.g. as shown in FIG. 3).

It will be understood that only the first side of the glue board 36 is coated with adhesive 37. An outer, second surface of the glue board is not coated with adhesive. It will be further understood that the first surface need not be completely coated with adhesive and a frame of non-adhesive material may surround the adhesive material in order to assist in handling.

Referring to FIG. 3, folded glue board 36 is inserted into the internal cavity 24 of the unit such that the outer surface of the first glue board section 36a rests on the inner surface of bottom wall 20. Second section 36b of glue board 36 forms a substantially vertical wall. Thus, second section 36b of glue board 36 is a partition that forms a first chamber 40 within internal cavity 24 and a second chamber 42.

In embodiments of the invention, width of first chamber 40 is defined by inner surface of rear wall 14 and substantially parallel wall created by outer (e.g. non-adhesive coated) surface of second section 36b of glue board 36. The length of first chamber 40, is defined by right and left walls 16, 18. It will be understood that because the non-adhesive side of glue board 36 faces first chamber 40—there is no danger of a rodent contacting the adhesive.

In embodiments of the invention, the width of second chamber 42 is defined by the inner surface of front wall 12 and inner surface of second section 36b of glue board 36. The length of second chamber 42, is defined by right and left walls 16, 18.

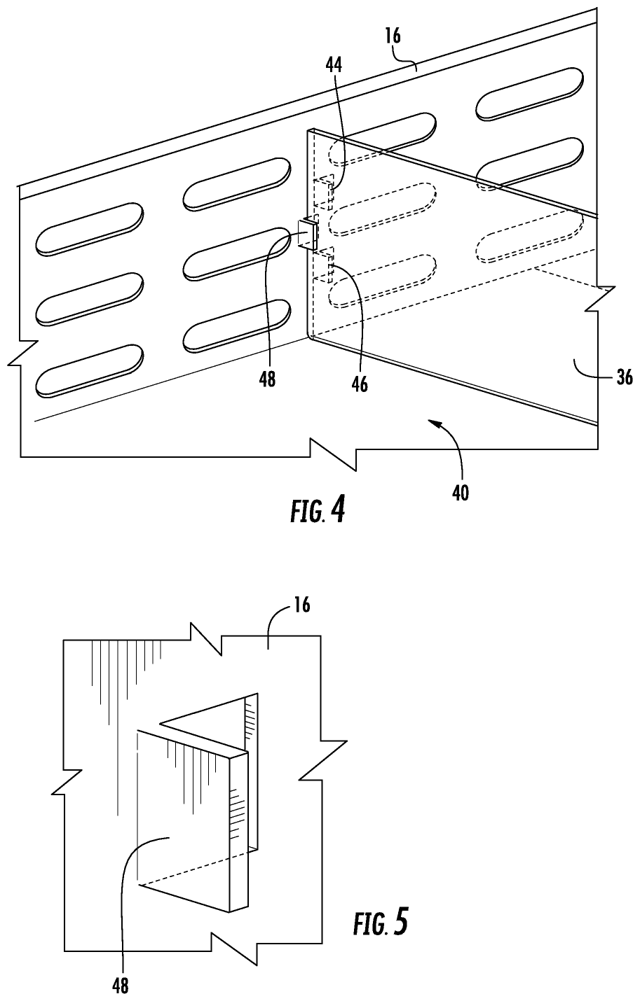

In embodiments of the invention the inner surface of one of, or both of, sidewalls 16, 18 are provided with tabs to maintain second section 36b of glue board in a substantially vertical position. For example, as shown in FIG. 4, two tabs 44, 46 are provided substantially in line (e.g. one directly above the other) along a vertical segment of sidewall 16. A third tab 48 is provided between first and second tabs 44, 46 but offset therefrom. In other words, third tab 48 is spaced away from a line defining first and second tabs 44, 46. In embodiments of the invention, the distance between third tab 48 and the line occupied by first and second tabs 44, 46 is incrementally greater than the thickness of a glue board 36. In this manner, second section 36b of glue board 36 may be positioned between tabs 44 and 46 which contact a first side of glue board 36 and tab 48 which contact a second side of glue board 36. The tabs provide a physical barrier which prevent the glue board 36 from folding down on itself and from opening further than around 90°. As such, second section 36b of glue board 36 is maintained substantially in a vertical position.

In embodiments of the invention, tabs 44, 46, 48 are formed by making a three-sided cut in any of the sidewalls and then folding wall area defined by the cut into the space of the internal cavity 24 of the multi-catch unit. FIG. 5 shows an exemplary enlarged view of tab 48 formed as described.

In embodiments of the invention the tabs 44, 46, are sized and shaped to contact an outer frame of non-adhesive material that surrounds the adhesive material.

In use, tunnels 28 are inserted into the multi-catch unit 10 and mechanical traps are similarly inserted, baited and set. The glue board 36 is folded and inserted to form the first and second chambers as described. The cover 22 is then closed and the multi-catch unit is set in a place where rodents and/or insects are suspected. Rodents may enter through cutouts in either right or left wall 16, 18, through a respective tunnel and into the first chamber. Once inside, a rodent attempting to eat the bait in any of the mechanical traps will become trapped and immediately killed. As stated, once inside first chamber 40, a rodent will be prevented from entering into second chamber.

Similarly, insects that may crawl into any of various openings 27 in sidewalls 16, 18 will contact the inner (adhesive coated) surface of the glue board 36 and become trapped.

Having described this invention with regard to specific embodiments, it is to be understood that the description is not meant as a limitation since further modifications and variations may be apparent or may suggest themselves to those skilled in the art. It is intended that the present application cover all such modifications and variations.

What is claimed is:

1) A trap unit, comprising:
a housing comprising a right wall having an outside surface and an inner surface, a left wall having an outside surface and an inner surface, a right wall having an outside surface and inner surface;
a bottom wall having an underside surface and an inner surface;
the left wall, right wall and bottom wall forming an internal cavity;
a first opening in the right wall that is configured to accommodate the ingress of a rodent;
a second opening in the right wall that is smaller than the outside dimensions of a rodent;
a glue board having a first side comprising adhesive material and a second side that is not provided with adhesive material, the glue board further comprising a line across a longitudinal section being configured to focus a fold, whereby the glue board is formable into a first section and a second section that is substantially orthogonal to the first section; and
one or more tabs on the inner surface of the right wall configured to maintain the second section of the glue board substantially vertically.

2) The trap unit of claim 1, whereby the second section of the glue board oriented vertically forms a first chamber and a second chamber within the internal cavity.

3) The trap unit of claim 2, the first chamber comprises at least inner surface of bottom wall and a substantially vertical wall comprising the second side of second section of the glue board.

4) The trap unit of claim 3, whereby the first opening opens into the first chamber.

5) The trap unit of claim 2, wherein the second chamber comprises at least a substantially horizontal floor comprising a first section of the glue board and a substantially vertical wall comprising at least a second section of the first side of the glue board.

6) The trap unit of claim 5, whereby the second opening opens into the second chamber.

7) The trap unit of claim 1, whereby the line across a longitudinal section being configured to focus a fold comprises any one of a score, a thinned area of the glue board or a previously imparted fold.

8) The trap unit of claim 1, wherein the one or more tabs on the inner surface of the right wall comprises a first tab configured to contact the first side of the second section of the glue board and a second tab configured to contact the second side of the second section of the glue board.

9) The trap unit of claim 1 further comprising, a first opening in the left wall that is configured to accommodate the ingress of a rodent and a second opening in the left wall that is smaller than the outside dimensions of a rodent.

10) The trap unit of claim 9 further comprising a front wall and a rear wall.

11) The trap unit of claim 10 whereby the right wall, left wall, front wall and rear wall form a rectangular internal cavity.
